(19) United States
(12) Patent Application Publication
(10) Pub. No.: US 2005/0131693 A1
(43) Pub. Date: Jun. 16, 2005

(54) Voice recognition method

(75) Inventor: Chan-Woo Kim, Gyeonggi-Do (KR)

Correspondence Address: JONATHAN Y. KANG, ESQ;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/013,985

(22) Filed: Dec. 15, 2004

(30) Foreign Application Priority Data
Dec. 15, 2003 (KR) 10-2003-0091481

(51) Int. Cl. G10L 15/16

(52) U.S. Cl. 704/248

(57) ABSTRACT

A method for recognition of a voice signal. The method comprising detecting an end point of the voice signal, extracting a transition point of the voice signal, determining distances between grids associated with the transition point using a DTW algorithm, and obtaining an overall global distance using dynamic programming associated with the distances obtained between the grids.

### CROSS-REFERENCE TO RELATED APPLICATIONS

Pursuant to 35 U.S.C. § 119(a), this application claims the benefit of earlier filing date and right of priority to Korean Application No. 10-2003-0091481 filed on Dec. 15, 2003, contents of which are hereby incorporated by reference herein in its entirety.

### BACKGROUND OF THE INVENTION

1. Field of the Invention

The present invention relates to a voice recognition method and, more particularly, a method using DTW (Dynamic Time Warping) for providing enhanced speech recognition that is substantially speaker-independent.

2. Description of the Related Art

Conventional voice recognition systems may be a stand-alone system or a software application for a general computer. Conventional voice recognition systems utilize techniques such as Dynamic Time Warping (DTW) or a Hidden Markov Model (HMM). A HMM voice recognition system has limited utility due to the system requirements including numerous calculations requiring a large database. The DTW voice recognition system is used for a portable electronic device such as a cell phone.

FIG. 1 is a flow chart of a voice recognition procedure using a conventional DTW technique. A DTW voice recognition system receives a voice signal (S10), performs endpoint detection of the voice signal, finds sections of the voice signal having a voice component (S20), and extracts a vector in accordance with a frame of the voice signal (S30).

A sequence of vectors are coupled to form a test speech pattern. The test speech pattern is compared to a reference speech pattern stored in a database (S40). The reference speech pattern having a smallest global distance to that of the test speech pattern is recognized as the pronunciation of the voice signal (S50). The conventional DTW method recognizes speakers who speak similar to the reference speech pattern. However, the conventional DTW method has degraded recognition performance for speakers having unfamiliar speaking patterns. A conventional DTW method including multiple voice templates for recognizing speakers has exhibited a small improvement over the conventional DTW method using one voice template. The conventional DTW methods exhibit speech recognition problems for longer reference speech patterns.

FIG. 2 is a diagram illustrating a conventional grid pattern obtained by dividing a test speech pattern and a reference speech pattern into frames. As shown in FIG. 2, a test speech pattern and a reference speech pattern form a grid having regularly spaced intervals. A global distance is obtained from the grid by using a general DTW method.

Therefore, there is a need for a method that overcomes the above problems and provides advantages over other voice recognition procedures.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one embodiment, a method comprises detecting an end point of the voice signal, extracting a transition point of the voice signal, determining distances between grids associated with the transition point using a DTW algorithm, and obtaining an overall global distance using dynamic programming associated with the distances obtained between the grids. The transition point may be extracted between a voice containing portion and a non-voice containing portion of the voice signal. The transition point may be extracted between a silence portion and a speech portion of the voice signal. The transition point may be extracted utilizing a zero energy crossing methodology. The grid associated with the transition point is obtained by dividing into frames a test speech pattern extracted from the voice signal and a reference speech pattern. The global distance may be, in one example, obtained within a cell. The cell comprises information on at least one transition point.

In another embodiment, a method comprises receiving the voice signal and detecting an end point of the voice signal, extracting a transition point of the voice signal, and obtaining a global distance between points in each cell of the voice signal through dynamic programming within each cell for a portion of a transition region of a reference speech pattern and a test speech pattern. The method further comprises obtaining an overall global distance of an overall cell utilizing dynamic programming utilizing the global distance of each cell, and recognizing a voice signal corresponding to the reference speech pattern showing a smallest global distance.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

The invention will be described in detail with reference to the following drawings in which like reference numerals refer to like elements wherein:

FIG. 1 is a flow chart of a voice recognition procedure using a conventional DTW.

FIG. 2 is a diagram illustrating a conventional grid reference pattern obtained by dividing a test speech pattern and a reference speech pattern into frames.

FIG. 3 is a flow chart of a DTW voice recognition method in accordance with a preferred embodiment of the present invention.

FIG. 4 is a diagram illustrating grid frames obtained by dividing a test speech pattern and a reference speech pattern into frames in accordance with the preferred embodiment of the present invention.

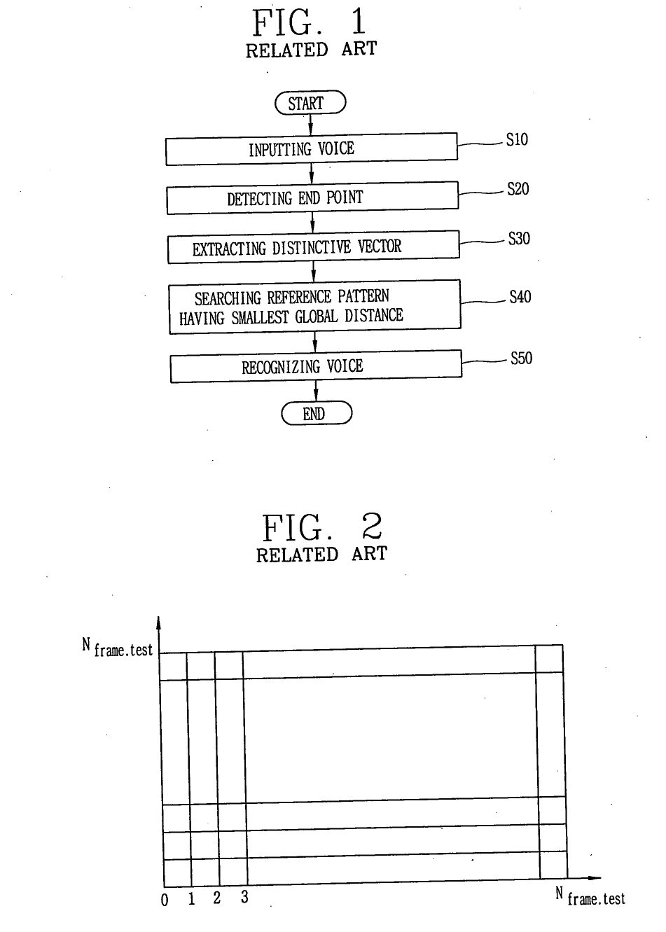

### DETAILED DESCRIPTION OF THE PREFERRED EMBODIMENTS

The invention relates to a voice recognition method providing enhanced speech recognition that is substantially speaker-independent.

Although the invention is illustrated with respect to a mobile terminal using Dynamic Time Warping (DTW) voice recognition algorithms, it is contemplated that the invention may be utilized anywhere it is desired for recognizing received voice signals. Reference will now be made in detail to the preferred embodiments of the present invention, examples of which are illustrated in the accompanying drawings. Preferred embodiments of the present invention will now be described with reference to the accompanying drawings.

The present invention sets points in a voice signal as a constraint for time alignment to achieve better voice recognition performance for longer sentences. The present invention monitors voiceless sound, voiced sound, sound transfer phenomenon, or existence of a non-sound interval in the middle portion of the voice signal which results in a system that is substantially speaker-independent.

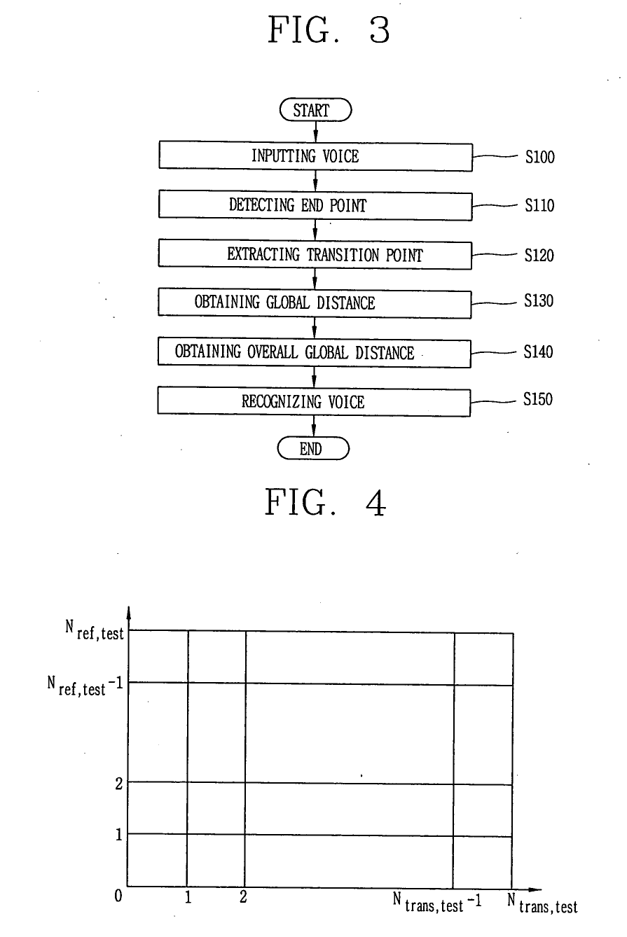

FIG. 3 is a flow chart of a Dynamic Time Warping (DTW) voice recognition method in accordance with a preferred embodiment of the present invention. In this method, a voice signal is inputted or received (S100). An end point of the voice signal is detected and used for searching a portion of the voice (S110). A transition point of the voice is extracted (S120). The transition point is preferably extracted using a transition between a voiced containing portion and an unvoiced containing portion of the voice signal. The transition point may, in yet another example, be obtained using a transition period between a speech portion and a silence portion. The transition point may be obtained by using a zero energy crossing point of the voice signal or using other like methods for extracting the transition point.

A square formed by information obtained at each transition point is called a cell. A global distance between points within the cell is determined using a general DTW method (S130). An overall global distance is obtained by a dynamic programming method with the global distance within the cell (S140). A reference speech pattern is compared to the voice signal. The reference speech pattern having a smallest global distance among the global distances obtained is recognized (S150). An overall global distance is obtained using a dynamic programming method utilizing the transition point for time alignment of a reference speech pattern and a test speech pattern. The time alignment feature of the present invention will be described with reference to FIG. 4.

FIG. 4 is a graph showing grid frames formed by dividing into frames a test speech pattern and a reference speech pattern in accordance with the preferred embodiment of the present invention. The horizontal axis indicates a time procession of the test speech pattern and the vertical axis indicates a time procession of the reference speech pattern. Connecting transition points of the test speech pattern and the reference speech pattern form grids. The intervals between the transition points are preferably not regularly spaced.

The present invention utilizes the transition points as a constraint during dynamic programming. This constraint provides for time aligning the test speech pattern and the reference speech pattern resulting in substantially more accurate voice recognition of the voice signal. A long sentence of words may have transition points dispersed throughout providing enhanced time alignment of the test speech pattern and the reference speech pattern.

A global distance is determined using a general DTW method for each cell, such as that illustrated in the conventional art described in FIG. 2. A local path constraint, which is utilized for the DTW, is also utilized to reduce the number of required voice recognition computations for moving among the grids. Upon determining the local path constraint, a global path constraint is created and applied. A local path constraint and the global path constraint are provided in frame units similar to the general DTW algorithm.

The local path constraint does not significantly affect the rate of voice recognition when the DTW algorithm has general frame units. To prevent errors in voice recognition when a user does not clearly speak, the local path constraint utilizes a relatively loose method compared with the dynamic programming method in the frame units. The present invention preferentially acquires spectral distortion of points corresponding to each frame grid. A global constraint is determined in the cells. If a global constraint is satisfied in a region indicating the next point as the transition point, dynamic programming is utilized to perform the next calculation.

Although the present invention is described in the context of a mobile terminal, the present invention may also be used in any wired or wireless communication systems using mobile devices, such as PDAs and laptop computers equipped with wired and wireless communication capabilities. Moreover, the use of certain terms to describe the present invention should not limit the scope of the present invention to certain type of wireless communication system, such as UMTS. The present invention is also applicable to other wireless communication systems using different air interfaces and/or physical layers, for example, TDMA, CDMA, FDMA, WCDMA, etc.

The foregoing embodiments and advantages are merely exemplary and are not to be construed as limiting the present invention. The present teaching can be readily applied to other types of systems. The description of the present invention is intended to be illustrative, and not to limit the scope of the claims. Many alternatives, modifications, and variations will be apparent to those skilled in the art. Accordingly, the invention is not limited to the precise embodiments described in detail herein above.

1. A voice recognition method for a voice signal, the method comprising:
detecting an end point of the voice signal;
extracting a transition point of the voice signal;
determining distances between grids associated with the transition point using a DTW algorithm, and
obtaining an overall global distance using dynamic programming associated with the distances obtained between the grids.

2. The method of claim 1, wherein the transition point is extracted between a voice containing portion and a non-voice containing portion of the voice signal.

3. The method of claim 1, wherein the transition point is extracted between a silence portion and a speech portion of the voice signal.

4. The method of claim 2, wherein the transition point is extracted utilizing a zero energy crossing methodology.

5. The method of claim 3, wherein the transition point is extracted utilizing a zero energy crossing methodology.

6. The method of claim 1, wherein the grid associated with the transition point is obtained by dividing into frames a test speech pattern extracted from the voice signal and a reference speech pattern.

7. The method of claim 1, wherein the global distance is obtained within a cell.

8. The method of claim 7, wherein the cell comprises information on at least one transition point.

9. The method of claim 1, wherein a global distance is obtained from the grid utilizing a local path constraint.

10. The method of claim 1, wherein the dynamic programming aligns a time period of a test speech pattern generated from the voice signal and a reference speech pattern.

11. The method of claim 1, further comprising:
recognizing a voice signal corresponding to a reference speech pattern having a smallest global distance between multiple transition points.

12. The method of claim 1, further comprising:
determining spectral distortion corresponding to points of each frame grid of the voice signal.

13. A voice recognition method for a voice signal, the method comprising:
receiving the voice signal and detecting an end point of the voice signal;
extracting a transition point of the voice signal;
obtaining a global distance between points in each cell of the voice signal through dynamic programming within each cell for a portion of a transition region of a reference speech pattern and a test speech pattern;
obtaining an overall global distance of an overall cell utilizing dynamic programming utilizing the global distance of each cell; and
recognizing a voice signal corresponding to the reference speech pattern showing a smallest global distance.

14. The method of claim 13, wherein the transition point is extracted between a voice containing and a non-voice containing portion of the voice signal.

15. The method of claim 13, wherein the transition point is extracted between a silence portion and a voice containing portion of the voice signal.

16. The method of claim 13, wherein the cell is a square comprising information on at least one transition point contained in the cell.

17. The method of claim 13, wherein the global distance is determined using a local path constraint.

18. The method of claim 13, wherein the dynamic programming creates a time alignment of the test speech pattern and the reference speech pattern.

19. The method of claim 13, further comprising obtaining spectral distortion for points corresponding to a frame grid of the voice signal.
